(19) United States
(12) Patent Application Publication
(10) Pub. No.: US 2013/0212237 A1
(43) Pub. Date: Aug. 15, 2013

(54) PROXY INFRASTRUCTURE TO ACCESS FIRMWARE-BASED FEATURES

(71) Applicants: Suhas SHIVANNA, Bangalore (IN); Neena Mohanachandran SAILAJA, Bangalore (IN)

(72) Inventors: Suhas SHIVANNA, Bangalore (IN); Neena Mohanachandran SAILAJA, Bangalore (IN)

(21) Appl. No.: 13/370,551

(22) Filed: Feb. 10, 2012

(51) Int. Cl. G06F 15/177; G06F 15/173

(52) U.S. Cl. 709/222; 709/223

(57) ABSTRACT

A customizable configuration data structure contains information regarding proxies to provide. A proxy infrastructure has a controller to read the customizable configuration data structure and to create the proxies. A management processor has firmware-based features, where the proxies are to access the firmware-based features through an interface between the proxy infrastructure and the management processor.

### BACKGROUND

A processing system, such as a server system, storage system, or communications system, can provide various services to requestors. For example, a server system can be used to run applications at the request of requestors. A storage system can be used to manage storage of data in storage devices. A communications system can be used to manage the communication of data between electronic devices. In some cases, a processing system can be accessed from a remote location to manage various capabilities of and/or manage issues that may arise in the processing system.

### BRIEF DESCRIPTION OF THE DRAWINGS

Some embodiments are described with respect to the following figures:

FIG. 1 is a block diagram of an example processing system according to some implementations;

FIG. 2 is a block diagram of a server system according to further implementations;

FIGS. 3A and 3B are flow diagrams of processes of a proxy infrastructure according to some implementations; and

FIG. 4 is a flow diagram of a process of a management processor according to some implementations.

### DETAILED DESCRIPTION

A processing system, such as a server system, storage system, communications system, or other type of system, can include a management processor (or multiple management processors) for managing the capabilities of and/or to manage issues that may arise in the processing system. The management processor is accessible remotely by a user or other entity (e.g. application, machine, etc.). Commands can be sent to the management processor to perform requested tasks, and information produced by the management processor can be displayed in a user interface.

As an example, the management processor can be used to perform management of partitions of the processing system. The processing system can be divided into multiple partitions, with the respective partitions including corresponding resources (e.g. processors, storage devices, input/output devices, etc.). As other examples, the management processor can manage faults or other issues that may arise in the processing system. Faults can be due to failures of electronic devices, errors during execution of machine-readable instructions, and so forth. Another capability of the processing system that can be managed by a management processor is an instant capacity feature, where an entity (e.g. user, application, etc.) can activate a resource of a system on demand. For example, a user may have paid for an allocation of two processors in the system, but the user may also have paid some predefined amount to reserve the ability to use an additional two processors. The management processor can be used to activate the additional two processors for use by the user on demand.

As other examples, the management processor can also be used to perform thermal management (to manage temperature conditions in the processing system), to perform power management (to manage power in the processing system), and so forth.

A “management processor” can refer to a processor (or a collection of processors) that can be configured to perform predetermined tasks, including the management of the capabilities and/or issues discussed above. In some examples, the management processor can be implemented as a microprocessor, a microcontroller, an application-specific integrated circuit (ASIC), a programmable gate array, or any other type of control device.

A management processor can be configured using embedded firmware, which includes machine-readable instructions that are provided (embedded) in the management processor. The firmware of the management processor can reside in a storage element (e.g. a read-only memory, a flash memory, etc.) that is part of the management processor. The firmware can be executed in the management processor to provide predefined management features—such features are referred to as “firmware-based features.”

Even though management features can be provided using firmware in a management processor, it may be desirable to provide a user interface using an entity that is separate from the management processor (and the firmware infrastructure of the management processor). Such an entity can be in the form of a proxy, which can be provided as part of an operating system, or as part of some other higher-level layer (e.g. application layer, etc.) of the processing system. A proxy acts as an intermediary between a requestor (e.g. a user at a user console, for example) and the corresponding management feature of the management processor.

The management processor can provide multiple management features, which can be implemented with corresponding firmware modules in the management processor. To interface with such multiple firmware modules of the management processor, multiple proxies can be provided. In some examples, the multiple proxies for the multiple respective management features are provided as separate products that are to be separately installed into the processing system. However, implementing proxies as separate products can result in increased development and maintenance costs.

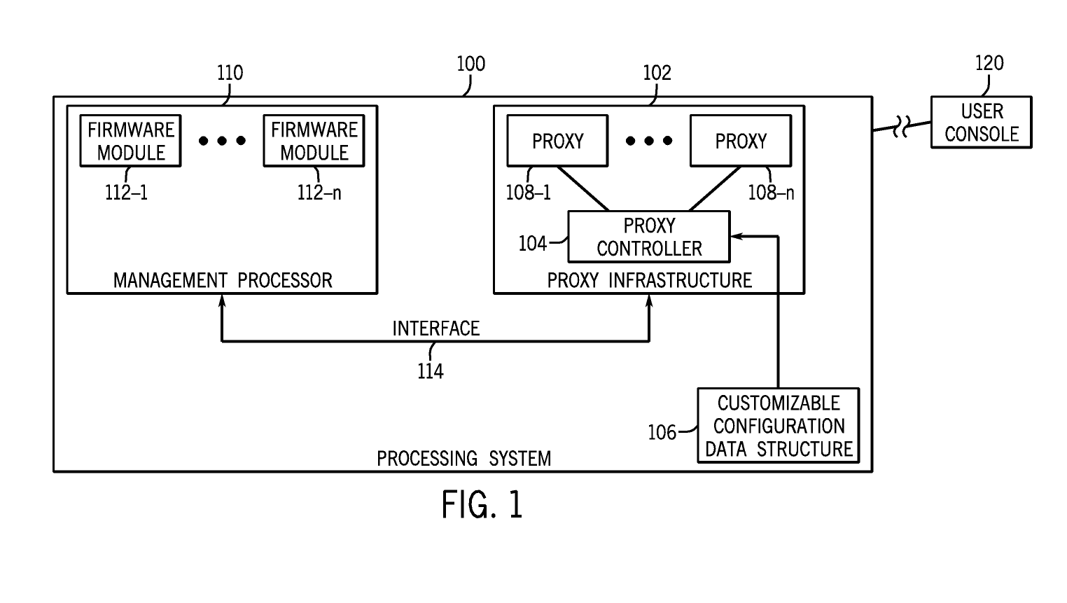

In accordance with some implementations, as shown in examples according to FIG. 1, to avoid having to provide multiple proxy products for accessing corresponding management features of a management processor, a processing system 100 includes a proxy infrastructure 102, which includes a proxy controller 104. The proxy controller 104 can be implemented as a module including machine-readable instructions. The proxy controller 104 is able to access a customizable configuration data structure 106, which can be stored in a storage medium. In some examples, the customizable configuration data structure 106 can be in the form of a configuration data file or multiple configuration data files.

The customizable configuration data structure 106 contains information regarding proxies 108-1 to 108-n that are to be provided by the proxy infrastructure 102. The value of n can be two or greater. The proxy controller 104 uses information in the customizable configuration data structure 106 to create the proxies 108-1 to 108-n.

The configuration data structure 106 is “customizable” since the content of the configuration data structure 106 can be updated or revised to support updated or different proxies. For example, as management features of a management processor 110 are updated or replaced, the content of the customizable configuration data structure 106 can be changed to support the updated or replaced management features. In this way, updating or replacing a management feature of the management processor 110 does not have to involve installing an updated or new proxy product into the processing system 100. Instead, the proxy controller 104 uses updated information in the customizable configuration data structure 106 to update one or more of the proxies 108-1 to 108-n.

As depicted in FIG. 1, the management processor 110 includes firmware modules 112-1 to 112-n, to provide respective management features. In some implementations, the management features are referred to as “firmware-based features,” since these features are provided by respective firmware modules 112-1 to 112-n embedded in the management processor 110. The proxies 108-1 to 108-n are able to interact with the firmware-based features provided by the firmware modules 112-1 to 112-n through an interface 114 provided between the management processor 110 and the proxy infrastructure 102.

The processing system 100 is coupled to a user console 120 (e.g. a desktop computer, a notebook computer, a tablet computer, a personal digital assistant, etc.). The user console 120 can be remote from the processing system 100, and can be coupled to the processing system 100 over a data network (e.g. Internet, local area network, wireless network, etc.). In alternative examples, the user console 120 can be locally located at the processing system 100. A user (or an application) at the user console 120 is able to invoke commands for submission to the management processor 110 for invoking respective firmware-based features. Also, the user console 120 can be used to display result information provided by the management processor 110 due to provision of respective firmware-based features. The interaction between the user console 120 and the management processor 110 is provided through the proxies 108-1 to 108-n.

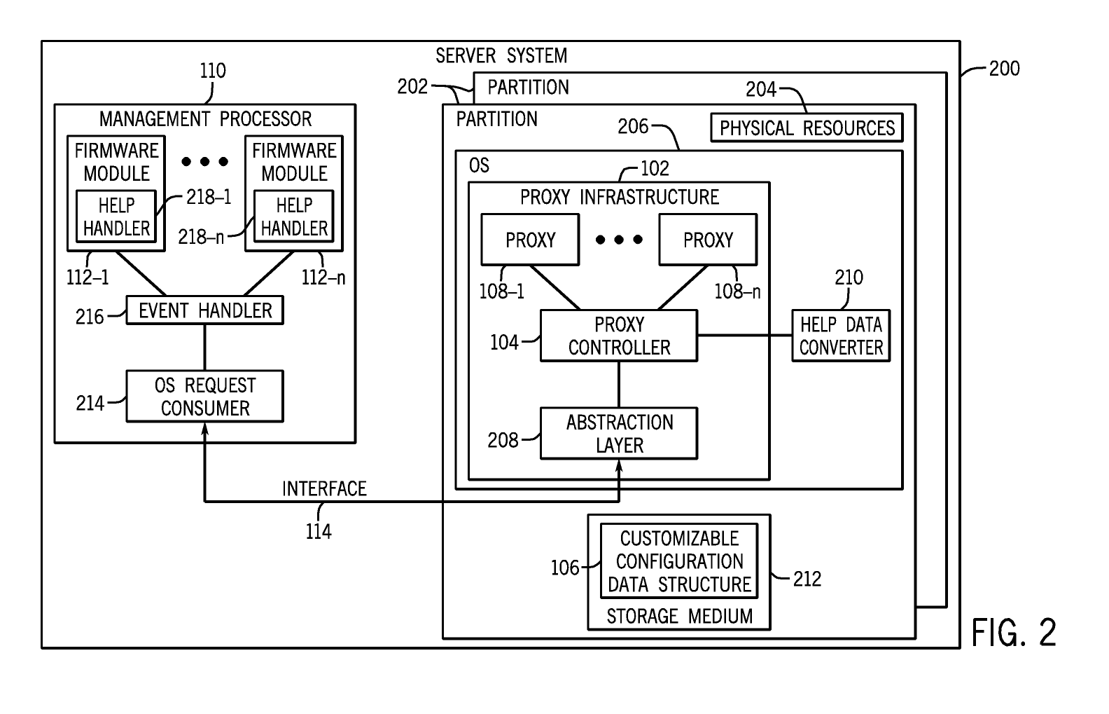

FIG. 2 illustrates an example arrangement according to alternative implementations. In FIG. 2, a server system 200 includes multiple partitions 202. Each partition 202 includes a respective set of physical resources 204 in the form of processors, input/output (I/O) devices, storage devices, and so forth. In alternative examples, the server system 200 is not divided into multiple partitions.

Each partition 202 further includes an operating system (OS) 206, which is executable on processor(s) of the physical resources 204. In some examples, the operating system 206 includes the proxy infrastructure 102 discussed above in connection with FIG. 1. Although the proxy infrastructure 102 is shown as being part of the operating system 206 in examples according to FIG. 2, it is noted that in other examples, the proxy infrastructure 102 can be part of a different layer of the server system 200, such as the application layer or some other layer.

In addition to the proxies 108-1 to 108-n and the proxy controller 104, the proxy infrastructure 102 depicted in FIG. 2 also includes an abstraction layer 208 to allow the proxy infrastructure 102 to communicate over the interface 114 with the management processor 110. The abstraction layer 208 allows for protocols used in the proxy infrastructure 102 to be abstracted to a protocol of the interface 114. In some examples, the interface 114 is an Intelligent Platform Management Interface (IPMI). In other examples, other types of interfaces can be used.

In some examples, the interface 114 is an in-band interface, which is an interface of the system 100 or 200 that is useable when the system 100 or 200 is operational. In other examples, the interface 114 can be an out-of-band interface, which is an interface that can be used to access the management processor 110 even if portions of the system 100 or 200 are not operational.

The partition 202 of FIG. 2 also includes a storage medium 212 to store the customizable configuration data structure 106 as discussed above. In addition, the operating system 206 includes a help data converter 210, which is used to convert a format of help data received from the management processor 110 to a different format that can be presented to a user, such as at a user console (e.g. 120 in FIG. 1).

Each of the firmware modules 112-1 to 112-n of the management processor 110 includes a respective help handler 218-1 to 218-n. Although FIG. 2 shows help handlers 218-1 to 218-n being included in respective firmware modules 112-1 to 112-n, it is noted that in other examples, the help handlers 218-1 to 218-n are separate from (but are associated with) respective firmware modules 112-1 to 112-n. The help handler of a firmware module manages the delivery of requested help data to the proxy infrastructure 102, in accordance with some implementations (discussed further below).

The management processor 110 also includes an OS request consumer 214, which receives and decodes requests received over the interface 114 from the proxy infrastructure 102. The decoded requests are forwarded to an event handler 216 of the management processor 110, where the event handler 216 is responsible for issuing corresponding commands to appropriate ones of the firmware modules 112-1 to 112-n, in response to the decoded requests. A result produced by a firmware module in response to a request is routed to the event handler 216 back over the interface 114 to the proxy infrastructure 102.

In a specific example, the content of the customizable configuration data structure 106 can include the following configuration data fields (in other examples, different content can be provided in the customizable configuration data structure 106):

PRODUCT ID: An identifier to identify a product (proxy) that is to be exposed to a user (such as at the user console 120 of FIG. 1). The management product corresponding to this identified product is present in the management processor (as one of the firmware modules 112-1 to 112-n).
PRODUCT COMMAND DIRECTORY: The directory where commands related to the identified product are available.
LICENSE STATUS: A current license status indicating if the product is available for use or not. The value of LICENSE STATUS is automatically calculated on each boot of the system 100 or 200 based on the LICENSE ENABLED FLAG (below).
LICENSE ENABLED FLAG: If the identified product is a licensed product (indicated by LICENSE STATUS), then the LICENSE ENABLED FLAG indicates the version(s) of the OS for which the identified product is to be enabled. For example, the identified product may be enabled for a particular version or versions of a Linux OS, a WINDOWS® operating system, and so forth, but not for other version(s) of particular operating systems.
SUPPORT COMMAND NAMES: The commands supported by the identified product that has an equivalent implementation on the management processor 110. These commands are provided in the PRODUCT COMMAND DIRECTORY noted above.
HELP COMMAND: The command used to obtain help data from the management processor 110.
HELP COMMAND OUTPUT FORMAT: A field to indicate the format of the help data. This field is used by the help data converter 210 (FIG. 2) to decode and convert the help data received from the management processor 110 into a man page or help file. “Man page” is short for manual page. A manual page includes documentation for the respective firmware-based feature supported by the management processor 110.
HELP COMMAND POLICY: A policy that indicates to the proxy controller 104 regarding how and when help data extraction is to be performed. This field helps to improve boot performance (such as by reducing boot time), particularly in situations where there is a relatively large amount of help data content. The HELP COMMAND POLICY field can have either a CREATE_ON_BOOT value or a LAZY_CREATE value. The CREATE_ON_BOOT value specifies that the help data is read from the management processor 110 to create a man page or help file, at initialization time of the proxy controller 104. The LAZY_CREATE value specifies that the help data is processed in the background without blocking the initialization of the proxy controller 104, thereby reducing the boot time of the proxy controller 104.

The foregoing provides example content for one product (proxy). The customizable configuration data structure 106 can include information for multiple different products (different proxies 108-1 to 108-n), each uniquely identified by a corresponding PRODUCT ID field. In implementations where the customizable configuration data structure 106 is a single configuration data file, the information for multiple products can be provided in different segments of the configuration data file. in implementations where the customization data structure 106 includes multiple configuration data files, the information for multiple products can be included in the respective different configuration data files.

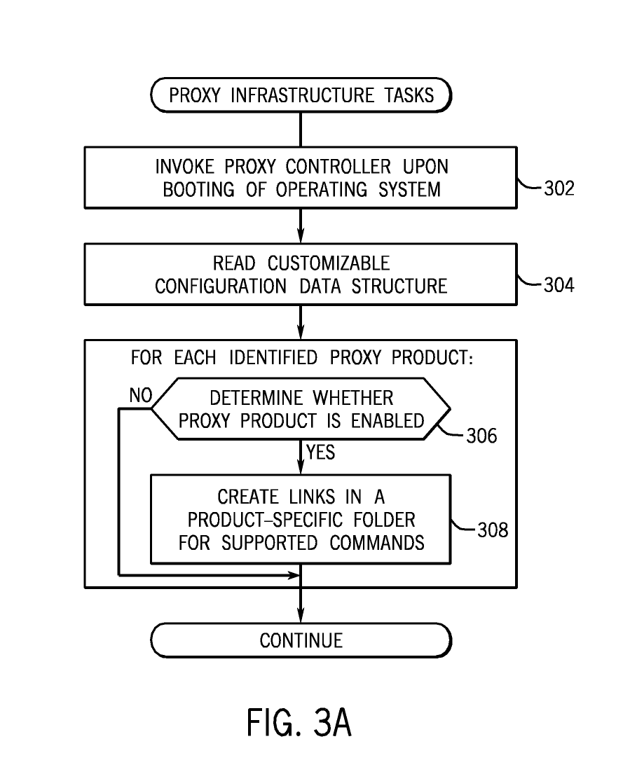

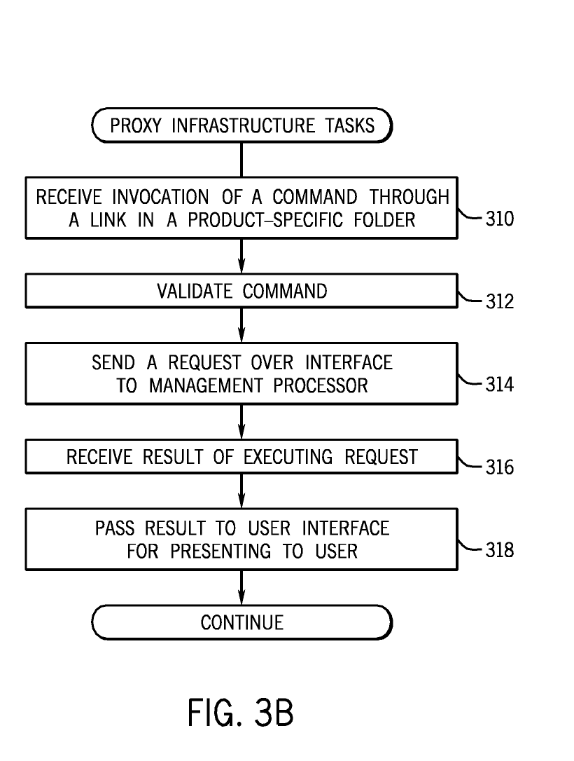

In operation, as depicted in FIG. 3A, the proxy controller 104 (FIG. 1 or 2) is invoked (at 302) upon booting of the OS 206. The proxy controller 104 reads (at 304) the customizable configuration data structure 106. For each proxy product identified (by PRODUCT ID) in the customizable configuration data structure 106, the proxy controller 104 performs the following tasks.

Assuming that the LICENSE STATUS field indicates that the corresponding proxy product is licensed, the proxy controller 104 then determines (at 306) whether the corresponding proxy product is enabled given the version of the installed OS 206. This determination is based on the LICENSE ENABLED FLAG field, which indicates the OS version(s) for which the corresponding proxy product is enabled.

If the proxy product is enabled, then the proxy controller 104 creates (at 308) links (or other types of references) in a product-specific folder (indicated by the PRODUCT COMMAND DIRECTORY field, for example) for commands supported by the corresponding proxy product (where the commands are listed in the SUPPORTED COMMAND NAMES field). The links can be softlinks, which are files or other data structures that provide references to locations of executable files corresponding to the commands that are supported. These softlinks are invocable by a requestor (e.g. user or application) to access a management feature of the management processor 110 through a respective proxy in the proxy infrastructure 102.

As further shown in FIG. 3B, when a requestor invokes a product-specific softlink (such as through a user interface presented by a corresponding one of the proxies 118-1 to 118-n) for activation of a corresponding management feature, the proxy controller 104 receives (at 310) the invocation of a command through the softlink that is in the corresponding product-specific folder, and the proxy controller 104 validates (at 312) the command corresponding to the invoked softlink against the supported command names (specified by the SUPPORTED COMMAND NAMES field) corresponding to the respective proxy product. The proxy controller 104, after validating the command, invokes the firmware-based feature by sending (at 314) a request along with values of parameters provided by the requestor, through the interface 114 to the management processor 110. The request is passed through the abstraction layer 208 of the proxy infrastructure 102 to the interface 114.

A result of executing the request by the management processor 110 is sent by the management processor 110 and received (at 316) by the proxy controller 104. The result is then passed (at 318) by the proxy controller 104 to a user interface presented by a corresponding one of the proxies 118-1 to 118-n.

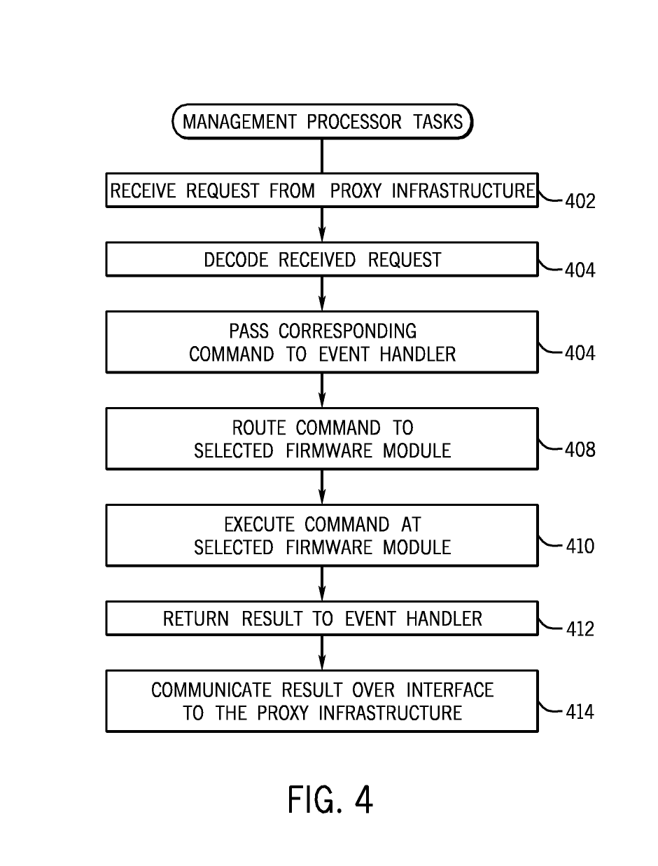

FIG. 4 is a flow diagram of a process performed by the management processor 110, in accordance with some implementations. When a request is sent over the interface 114 by the proxy infrastructure 102, the OS request consumer 214 (FIG. 2) in the management processor 110 receives (at 402) the request. The OS request consumer 214 decodes (at 404) the received request, to produce a corresponding command. The command is passed (at 406) to the event handler 216 (FIG. 2) in the management processor 110, which routes (at 408) the command to a selected one of the firmware modules 112-1 to 112-n of the management processor 110. The selected firmware module is the one corresponding to the one of the proxies 118-1 to 118-n that provided the request.

The selected firmware module 112-1 to 112-n executes (at 410) the command and returns (at 412) a result to the event handler 216, which communicates (at 414) the result back over the interface 114 to the proxy infrastructure 102. The result can include an output of an executed command. As another example, if the request from the proxy infrastructure 102 is a request for help data, then the result can be help data provided by the respective firmware module 112-1 to 112-n of the management processor 110.

Using techniques or mechanisms according to some implementations, a generic proxy infrastructure, such as the proxy infrastructure 102, can be used to implement multiple proxies for firmware-based features supported by the management processor 110. The generic proxy infrastructure is thus able to support multiple user interfaces for the corresponding firmware-based features. By using the generic proxy infrastructure, individual proxy products that have to be separately installed do not have to be deployed.

Moreover, based on content of the customizable configuration data structure 106, the different products (proxies 108-1 to -108-n) can be independently and individually licensed to control access of respective firmware-based features in the management processor 110.

By providing a multi-product interface and a common generic proxy infrastructure 102, the overall solution of providing proxies for firmware-based features of a management processor is simplified, such that development and maintenance costs can be reduced. Moreover, resource utilization on the OS side is reduced by using the generic proxy infrastructure along with the customizable configuration data structure.

As noted above, the firmware infrastructure (including the firmware modules 112-1 to 112-n) of the management processor 110 is responsible for delivering help data to the proxy infrastructure 102. By using the firmware infrastructure to deliver help data, it can be assured that the help data provided for a particular management feature of the management processor 110 is the correct help data for the management feature. As a management feature of the management processor 110 is upgraded, additional options may become available, for which help data can be provided. Also, help data for a management feature may be updated over time (such as in response to user feedback).

With approaches where help data for a management feature is provided at the operating system, the help data may not be synchronized with the version of the management feature. Developers attempt to synchronize help data with each release of an operating system to align with the latest firmware-based features. However, if synchronization is not provided, user confusion may result if the help data provided by an operating system is inconsistent with options of a current release of a management feature.

In accordance with some implementations, by providing help data from the firmware infrastructure of the management processor 110, it can be assured that a requestor receives the correct version of the help data. The help data can be in the form of a manual page (or man page) or some other type of help data. A manual page or man page includes documentation for the respective firmware-based feature supported by the management processor 110. In response to a request from the proxy infrastructure 102 for help data, the corresponding help handler 218-1 to 218-n in the management processor 110 provides the help data (in a first format) over the interface 114 to the operating system 206.

In some implementations, retrieval of help data from the management processor 110 is initiated at boot time of the operating system (e.g. 206 in FIG. 2). Effectively, this provides help data linking at OS boot time, which allows for the implementation of the operating system 106 to be decoupled from the firmware infrastructure in the management processor 110. Also, with help data linking performed at OS boot time, portable OS images can be implemented. A portable OS image refers to an image of an operating system that can work with different platforms.

The help data converter 210 in the operating system 206 converts the help data from the first format to a second, different format. The second format of the help data is a format that is viewable by a user in the user interface provided by the respective proxy 108-1 to 108-n.

In some examples, the help data converter 210 can convert the help data received from the management processor 110 to either an NROFF format (which is a format used by a Unix text-formatting program) or another format such as text, HTML (Hypertext Markup Language), XML (eXtensible Markup Language), and so forth.

The help data in the first format (as returned by the management processor 110) can be in a generic format, such as XML or text (with generic format/control sequences). The first format can allow for reduction of the amount of help data that has to be communicated over the interface 114. The help data converter 210 (FIG. 2) can decode these format/control sequences in the first format to the man page or help data format supported by the operating system 206.

Also, by employing the help data converter 210 in the operating system 206, help data can be flexibly provided for different operating system and platforms.

The help data converter 210 can read the HELP COMMANDS POLICY field of the customizable configuration data structure 106 for the corresponding product to determine the policy to use for creating help files based on help data received from the firmware modules of the management processor 110. There can be two types of policies for creating the help files. The first policy specifies that the help files are to be created in a single shot at initialization of the proxy controller 104 (during initialization or boot of the operating system).

This first policy is used when the HELP COMMAND POLICY field has the CREATE_ON_BOOT value (as discussed above). If the HELP COMMAND POLICY field has the CREATE_ON_BOOT value, then the help data (of a particular language) is obtained from the firmware infrastructure of the management processor 110. The help data converter 210 (FIG. 2) then converts the help data from the first format to the second format (to produce the respective help files) as part of the initialization procedure of the proxy controller 104. The foregoing procedure can be performed for each of the licensed products to produce the respective help files. After all help files have been produced, the initialization of the proxy controller 104 is completed.

A second policy is used when the HELP COMMAND POLICY field has the LAZY_CREATE value (as discussed above). This second policy causes the help files to be created lazily (in the background). To do so, the operating system 206 (FIG. 2) creates background entities (processes or threads) to read help data from the firmware infrastructure of the management processor 110. The background processes or threads then convert the help data from the first format to the second format. Using the second policy, the proxy controller 104 completes its initialization prior to completion of help data conversion. After initialization of the proxy controller 104, the background processes or threads can continue to perform help data extraction and conversion.

The second policy (lazy policy) helps to speed up the boot procedure of the proxy controller 104, since the boot procedure does not have to wait for all help data to be converted prior to completion. However, use of the lazy policy may result in help data being unavailable for some amount of time after OS boot.

Machine-readable instructions of various modules described above (including those in FIG. 1 or 2) are loaded for execution on a processor(s). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A system comprising:
a customizable configuration data structure containing information regarding proxies to provide;
a proxy infrastructure having a controller to read the customizable configuration data structure and to create the proxies; and
a management processor having firmware-based features, wherein the proxies are to access the firmware-based features through an interface between the proxy infrastructure and the management processor.

2. The system of claim 1, wherein the interface is an in-band interface, and the proxies are to access the firmware-based features through the in-band interface.

3. The system of claim 1, further comprising an operating system including the proxy infrastructure.

4. The system of claim 1, wherein the firmware-based features include multiple features selected from among a feature to manage at least a portion of a processing system, a feature to manage faults in the processing system, a feature to manage activation of a resource on demand, a thermal management feature, and a power management feature.

5. The system of claim 1, wherein the proxies are to provide corresponding user interfaces to the firmware-based features, the user interfaces to allow for user invocation of commands to activate the corresponding firmware-based features, and wherein the user interfaces are to present results provided by the firmware-based features.

6. The system of claim 1, wherein the controller is used to create, based on the information in the customizable configuration data structure, links for corresponding commands that are invocable by a user to access the firmware-based features.

7. The system of claim 6, wherein the controller is to communicate a request corresponding to an invoked one of the commands through the interface to the management processor.

8. The system of claim 7, wherein a particular one of the firmware-based features is to execute the invoked command and to return a result through the interface to the controller.

9. The system of claim 1, wherein the controller is to obtain help data from the firmware-based features, and the controller is to create help files corresponding to the obtained help data.

10. The system of claim 9, further comprising a help data converter to convert a format of the help data from the firmware-based features to a different format to allow for viewing by a user.

11. A method comprising:
providing a management processor having firmware-based features for managing a processing system;
storing, in a storage medium, a customizable configuration data structure storing information relating to proxies to provide to access the firmware-based features; and
providing a proxy infrastructure having a controller to access the customizable configuration data structure and to create the proxies based on the information in the customizable configuration data structure, the proxies to access the firmware-based features over an interface between the management processor and the proxy infrastructure.

12. The method of claim 11, wherein storing the customizable configuration data structure comprises storing the customizable configuration data structure that includes identifiers of the proxies and configuration data for the corresponding proxies.

13. The method of claim 12, wherein the configuration data includes fields corresponding to licensing of the proxies, and fields identifying commands that are supported by the firmware-based features corresponding to the proxies.

14. The method of claim 12, wherein the configuration data includes a field settable to plural different values corresponding to plural different techniques for creating help files for the firmware-based features.

15. The method of claim 11, further comprising revising the information in the customizable configuration data to correspond to a change of a firmware-based feature in the management processor.

16. The method of claim 11, further comprising:
at initialization of the controller, initiating retrieval of help data from a firmware infrastructure in the management processor, the firmware infrastructure to provide the firmware-based features.

17. The method of claim 16, further comprising:
accessing a field in the customizable configuration data structure;
in response to the field having a first value, completing conversion of the help data into respective help files for the firmware-based features prior to completion of booting of an operating system including the proxy infrastructure; and
in response to the field having a second, different value, performing conversion of the help data into respective help files using background entities.

18. A system comprising:
a management processor to manage the system, the management processor having firmware modules to provide firmware-based features;
a storage medium storing a customizable configuration data structure storing information relating to proxies to provide; and
a proxy infrastructure having a controller to create, based on the information in the customizable configuration data structure, the proxies, wherein the proxies are to interact with the firmware-based features through an interface between the proxy infrastructure and the management processor, and wherein the proxies are to provide user interfaces to allow for user invocation of commands for submission to the management processor.

19. The system of claim 18, wherein the controller is to obtain help data from the firmware modules, and the system further comprises a help data converter to convert the help data from a first format into help files according to a second, different format, the help files presentable through the user interfaces.
